(19) United States
(12) Patent Application Publication
(10) Pub. No.: US 2024/0031970 A1
(43) Pub. Date: Jan. 25, 2024

(54) APPARATUS AND METHOD FOR SUPPORTING COMMUNICATION SERVICE CONTINUITY IN WIRELESS COMMUNICATION SYSTEM

(71) Applicant: Samsung Electronics Co., Ltd., Suwon-si (KR)

(72) Inventor: Kyungjoo SUH, Suwon-si (KR)

(21) Appl. No.: 18/358,788

(22) Filed: Jul. 25, 2023

(30) Foreign Application Priority Data
Jul. 25, 2022 (KR) 10-2022-0091997

(51) Int. Cl. H04W 60/00; H04W 48/02; H04W 12/06

(52) U.S. Cl. CPC H04W 60/00; H04W 48/02; H04W 12/06

(57) ABSTRACT

The disclosure relates to a 5G or 6G communication system for supporting higher data transmission rates. A method of a terminal in a wireless communication system according to the disclosure includes transmitting a first registration request message to an access and mobility management function (AMF) through a base station, receiving, as a response to the first registration request message, a registration rejection message from the AMF through the base station, and transmitting, based on the registration rejection message, a second registration request message to the AMF through the base station.

### CROSS-REFERENCE TO RELATED APPLICATION(S)

This application is based on and claims priority under 35 U.S.C. § 119 to Korean Patent Application No. 10-2022-0091997, filed on Jul. 25, 2022, in the Korean Intellectual Property Office, the disclosure of which is herein incorporated by reference in its entirety.

### BACKGROUND

### 1. Field

The disclosure relates to a wireless communication system and, more specifically, to an apparatus and a method for supporting communication service continuity.

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-outlet (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio user equipment (NR UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices, which have been exponentially increasing, will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The present disclosure relates to an apparatus and a method for providing a network slice to a terminal that is moving in a wireless communication system.

According to the disclosure, an operation method of a terminal in a wireless communication system includes transmitting a first registration request message to an access and mobility management function (AMF) through a base station, receiving, as a response to the first registration request message, a registration rejection message from the AMF through the base station, and transmitting, based on the registration rejection message, a second registration request message to the AMF through the base station.

According to the disclosure, a terminal in a wireless communication system includes a transceiver, and a processor coupled to the transceiver. The processor is configured to transmit a first registration request message to an AMF through a base station, receive, as a response to the first registration request message, a registration rejection message from the AMF through the base station, and transmit, based on the registration rejection message, a second registration request message to the AMF through the base station.

The first registration request message may include an indication requesting authentication of a network slice of the terminal in a unit of tracking area, an indication indicating that the terminal is capable of authenticating the network slice of the terminal in the unit of tracking area, an indication indicating that the terminal is capable of receiving and using authentication information of the network slice of the terminal, and an indication indicating that the terminal is capable of performing communication using the authentication information.

The first registration request message may include information about a tracking area associated with a network slice for which a service request is desired by the terminal, and information about the network slice.

The registration rejection message may include at least one of a list of tracking areas determined based on the first registration message, information about a network slice available in a tracking area, and authentication information for the network slice.

The registration rejection message may include a list of tracking areas determined based on the first registration message, information about a network slice unavailable in a tracking area, authentication information for the network slice, and information about a network slice for which authentication failed in the tracking area.

The registration rejection message may include a list of tracking areas determined based on the first registration message, information about a network slice unavailable in a tracking area, information about the network slice for which authentication has been attempted in the tracking area but has failed, and authentication information for the network slice.

The registration rejection message may be generated based on a first authentication response message transmitted from a session management function (SMF) to an AMF. The first authentication response message may include a list of tracking areas determined based on the first registration request message, information about network slices available in tracking areas, and authentication information about the network slices.

The first authentication response message may be generated based on a second authentication response message transmitted from authentication, authorization and accounting (AAA) to the SMF.

The second authentication response message may include an indication indicating that the wireless communication system has the capability of supporting and configuring the network slices in a unit of tracking area determined based on the first registration request message, and an indication indicating that establishment, management, or authentication of the network slices in the unit of tracking area are permitted.

The second authentication response message may be generated based on an authentication request message transmitted from the SW′ to the AAA.

The authentication request message may include a tracking area code (TAC) and a granularity indication indicating that the terminal uses the network slices in the unit of tracking area determined based on the first registration request message.

The authorization request message may be generated based on network slice configuration information determined based on the first registration request message.

The network slice configuration information may include at least one of an indication indicating that the granularity of mobility or authentication associated with the network slice for the terminal is configured in the unit of tracking area, and an indication indicating a mutual mapping relationship between information about the tracking area and authentication information about the tracking area.

The disclosure can efficiently support a network slice and a network slice service to a terminal that is moving in a wireless communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a conceptual diagram of a terminal and a network environment for providing communication to a user equipment (UE) that is moving in a 5G network environment by considering slices according to an embodiment of the present disclosure;

FIG. 2 illustrates a flow diagram of a procedure for providing communication to a UE that is moving in a 5G network environment by considering slices according to an embodiment of the present disclosure;

FIG. 3 illustrates a flow diagram of a procedure for providing communication to a UE that is moving in a 5G network environment by considering slices according to another embodiment of the present disclosure;

FIG. 4 illustrates a flow diagram of a procedure for providing communication to a UE that is moving in a 5G network environment by considering slices according to another embodiment of the present disclosure;

FIG. 5 illustrates a flow diagram of a procedure for providing communication to a UE that is moving in a 5G network environment by considering slices according to another embodiment of the present disclosure;

FIG. 6 illustrates a flow diagram of a procedure for providing communication to a UE that is moving in a 5G network environment by considering slices according to another embodiment of the present disclosure;

FIG. 7 illustrates a block diagram of a UE according to an embodiment of the present disclosure; and

FIG. 8 illustrates a block diagram of network entities according to an embodiment of the present disclosure.

### DETAILED DESCRIPTION

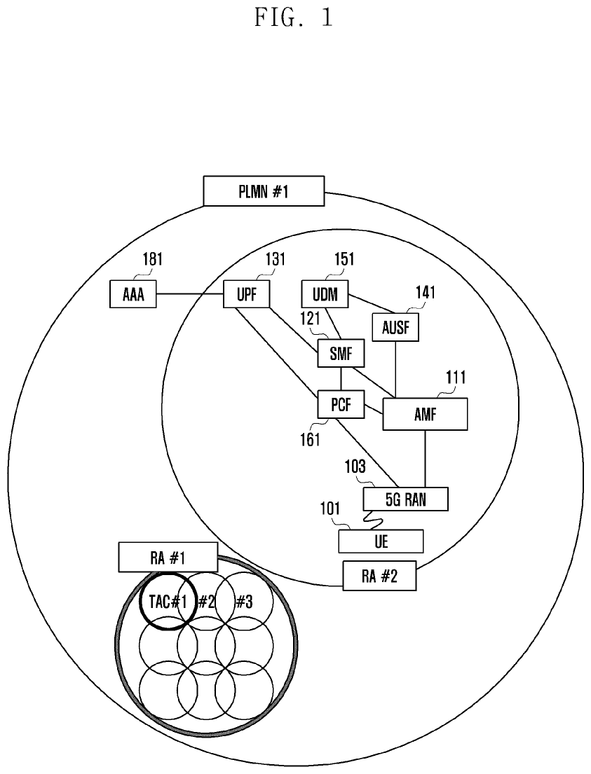

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments are described in detail with reference to the accompanying drawings. In the drawings, the same reference numerals denote the same elements. Well known functions or structures may not be described or illustrated in detail to avoid obscuring the subject matter of the disclosure.

In the accompanying drawings, some components may be exaggerated, omitted, or schematically illustrated. Further, the size of each component does not entirely reflect the actual size. In the drawings, identical or corresponding components may be provided with identical or similar reference numerals.

Various advantages and features of the disclosure and ways to achieve them will be apparent by making reference to embodiments as described below, in conjunction with the accompanying drawings. However, the disclosure is not limited to the embodiments set forth below, but may be implemented in various different forms. The following embodiments are provided only to inform those skilled in the art the scope of the disclosure, with the present disclosure being defined by the appended claims.

Each block of the flowchart illustrations, and combinations of blocks in the flowchart illustrations, can be implemented by computer program instructions, which may be mounted on a processor of a general purpose computer, a special purpose computer or other programmable data processing apparatus so that the instructions executed by the processor of the computer or other programmable data processing apparatus create means for executing the functions specified in the flowchart block(s). These computer program instructions may also be stored in computer-usable or computer-readable memory that can direct a computer or other programmable data processing equipment to function in a particular manner, such that the instructions stored in the computer-usable or computer-readable memory produce an article of manufacture including instruction means that implement the function specified in the flowchart block(s). The computer program instructions may also be loaded on a computer or other programmable data processing apparatus to cause a series of operational steps to be performed on the computer or other programmable apparatus to produce a computer-executed process, so that the instructions performing the computer or other programmable apparatus provide steps for executing the functions described in the flowchart block(s).

Further, each block may represent a portion of a module, a segment or code, which includes one or more executable instructions for implementing a specified logical function(s). It should also be noted that in some alternative implementations, the functions noted in the blocks may occur out of order. For example, two blocks shown in succession may in fact be executed substantially concurrently or the blocks may sometimes be executed in the reverse order, depending upon the functionality involved.

The term unit means software or a hardware component, such as a field programmable gate array (FPGA) or an application-specific integrated circuit (ASIC), and the unit performs specific tasks. However, the unit does not always have a meaning limited to software or hardware. The unit may advantageously be configured to reside on an addressable storage medium and configured to operate on one or more processors. Accordingly, the unit may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and units may be combined into fewer components and units or may be further separated into additional components and units.

Further, the components and units may be implemented to operate on one or more central processing units (CPUs) within a device or a security multimedia card. Hereinafter, a base station is the subject of resource assignment to a terminal, and may be at least one of an eNode B (eNB), a Node B (NB), a base station (BS), a radio access network (RAN), an access network (AN), an RAN node, a new radio (NR) NB, a gNB, a wireless access unit, a base station controller and a node in a network. Also, the base station may be a network entity including at least one of an integrated access and backhaul-donor (IAB-donor), which is a gNB providing network access to user equipment(s) (UE(s)) through a network of backhaul and access links in the NR system, and an IAB-node, which is an RAN node supporting NR backhaul links to the IAB-donor or another IAB-node and supporting NR access links to UEs. The UE is wirelessly connected through the IAB-node and may transmit/receive data to and from the IAB-donor connected with at least one IAB-node through the backhaul link. The UE may include a terminal, a mobile station (MS), a cellular phone, a smartphone, a computer, or a multimedia system capable of performing communication functions.

In the disclosure, downlink (DL) means the radio transmission path of a signal transmitted from a BS to a UE, and uplink (UL) means the radio transmission path of a signal transmitted from a UE to a BS. Further, although LTE- or LTE-A-based system is described in connection with embodiments, as an example, embodiments may also apply to other communication systems with similar technical background or channel form. Further, embodiments may be modified in such a range as not to significantly depart from the scope of the disclosure under the determination by one of ordinary skill in the art and such modifications may be applicable to other communication systems.

The description of embodiments of the disclosure is made mainly based on a new radio access network (new RAN) and packet core (a 5th generation (5G) system, a 5G core network, or a next generation (NG) core) which is a core network on the 5G mobile communication standard specified by the 3rd generation partnership project (3GPP), which is a mobile communication standardization group, but the main subject of the disclosure can be applied to other communication systems having a similar technical background with slight modification without departing from the scope of the disclosure, which can be determined by those skilled in the art.

FIG. 1 illustrates a conceptual diagram of a UE 101 and a network environment for performing communication with improved communication performance in a 5G network according to an embodiment of the present disclosure.

Referring to FIG. 1, the 5G network or NR core network may include network functions (NFs), such as user plane function (UPF) 131, a session management function (SMF) 121, an access and mobility management function (AMF) 111, a 5G radio access network (RAN) 103, a user data management (UDM) 151, and a policy control function (PCF) 161. In addition, the 5G network or NR core network may further include entities such as an authentication server function (AUSF) 141, and authentication, authorization and accounting (AAA) 181 to authenticate the above-mentioned entities. The UE (or terminal) 101 may connect to the 5G network or NR core network through a BS (or 5G RAN) 103. The 5G network or NR core network may further include an N3 interworking function (N3IWF) for communication of the UE 101 via non-3GPP access. For example, when the UE 101 performs communication via the non-3GPP access, session management may be controlled by the UE 101, the non-3GPP access, the N3IWF, and the SMF 121. For example, mobility management may be controlled by the UE 101, the non-3GPP access, the N3IWF, and the AMF 111.

In a 5G or NR system, the AMF 111 may perform mobility management. The SMF 121 may perform session management. On the other hand, the 5G or NR system may include a standalone deployment architecture in which communication is performed only using or NR entities, and a non-standalone deployment architecture in which communication is performed using both a 4G entity and 5G or NR entities.

For example, when the UE 101 performs communication with a network, a deployment using a 5G entity of a core network while performing control by the eNB is possible. For example, mobility management between the UE 101 and the AMF 111 and session management between UE 101 and SMF 121 may be performed on a non-access stratum (NAS) layer that is layer 3.

In accordance with the present disclosure, the communication network assumes a 5G, 4G LTE network but is not limited thereto, and the disclosure may be applied when the same concepts are applied to other networks or systems within the scope understood by a person skilled in the art.

In managing the mobility of the UE 101 in a 5G network, a plurality of cells may be managed as one tracking area and a plurality of tracking areas may be managed as one registration area in order to reduce the frequent occurrence of signal and message communication due to the movement of the UE 101. For example, in a 5G network, a network slice may be managed in the unit of registration area, and in a case where the use of the network slice is not permitted in a smaller unit of the tracking area configuring the registration area, the UE 101 is unable to receive services related to the network slice in the corresponding registration area.

The present disclosure relates to a method and an apparatus for supporting network slice services in a case where at least one tracking area, in which services for a network slice are supported, exists in a wireless communication system. The present disclosure may solve the problem of not being able to provide a network slice or network slice-related services due to the determination that even when one of the plurality of tracking area does not support the service for a network slice, and services related to the network slice in entire registration area are unavailable.

For example, the disclosure may, in a case where there is at least one tracking area that supports service for a network slice while the UE 101 is moving, provide a network slice service in the tracking area.

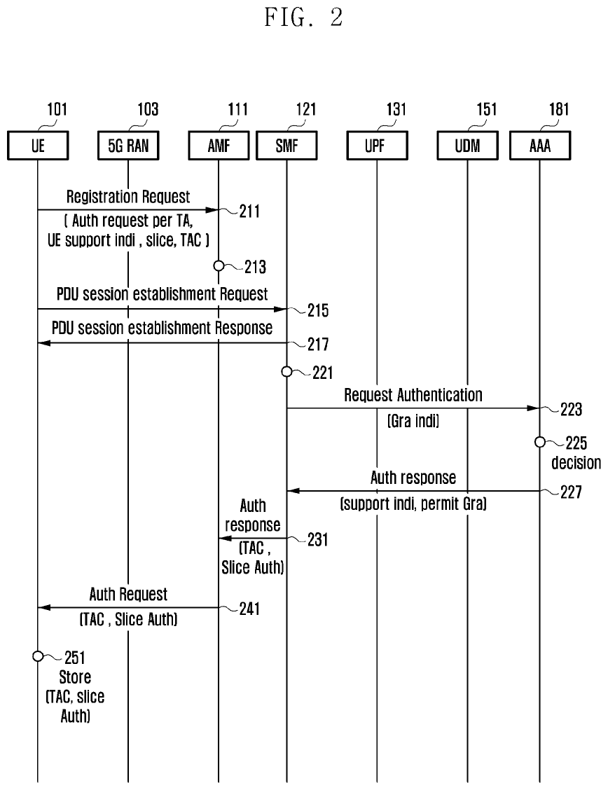

FIG. 2 illustrates a flow diagram of a procedure for providing communication to a UE 101 that is moving in a 5G network environment by considering network slices according to an embodiment of the present disclosure.

Referring to FIG. 2, in an operation 211, the UE 101 may transmit a registration request message to the AMF 111. For example, the registration request message may include at least one of the following pieces of information.

1) An indication (or information) for requesting the network to allow mobility tracking of the UE 101 in the unit of tracking area, register the location of the UE 101, and allow use and authentication of a network slice by the UE 101.

2) An indication for notifying the network that the UE 101 has the function of using and authenticating a slice in the unit of tracking area. This information includes information such as a bit or an indication notifying that the UE 101 has the capability of receiving authentication of a network slice in the unit of tracking area or performing communication using the corresponding authentication information.

3) Network slice information (e.g., network slice selection assistance information (NSSAI)) that the UE 101 uses to request service in the unit of tracking area. NS SAI may include (a) a slice/service type (SST) requested by a user terminal or (b) a slice differentiator (SD) corresponding to the user terminal and the slice/service type. For example, network slice #1(NSSAI #1), network slice #2(NSSAI #2), etc.

4) Tracking area information which the UE 101 desires to request for services related to a slice, such as a tracking area code (TAC). For example, when requesting use and authentication of a network slice in the unit of tracking area from network slice #1,the UE 101 may transmit TAC information to the network (e.g., the AMF 111).

In an operation 213, the AMF 111 may configure the granularity of mobility or authentication associated with a network slice to be used by the UE 101, in the unit of tracking area, based on the registration request message received from the UE 101.

For example, in an embodiment (case 1), the AMF 111 may configure the network slice to be used by the UE 101 and the granularity of mobility or authentication associated with the slice in the unit of tracking area, and may store a mapping relationship between information about the tracking area and authentication information about the tracking area. The information about the tracking area may include a TAC. For example, the AMF 111 may map NSSAI #1, which is the network slice information, to TAC #1, which is the tracking area information, and map NSSAI #2, NSSAI #3, and the like to TAC #2, and may further store information regarding whether the UE 101 is allowed to use the corresponding network slice (a network slice identified by the NSSAI) in each TAC.

In another embodiment (case 2), the AMF 111 may configure the granularity of mobility and authentication associated with a network slice to be used by the UE 101 in the unit of registration area.

The AMF 111 may transmit, to the SMF 121 or to the AAA 181 via the SMF, at least one of an indication for the mobility granularity to notify that the UE 101 is to use a network slice in the unit of tracking area, an indication (or bit or information) indicating that the UE 101 is using a network slice in the unit of tracking area, or information related to a TAC. For example, at least one of the SMF 121 or the AAA 181 may receive, from the AMF 111, an indication for the mobility granularity to notify that the UE 101 is to use a network slice in the unit of tracking area, an indication (or bit or information) to indicate that the UE 101 is using a network slice in the unit of tracking area, or information related to the TAC.

In an operation 215, the UE 101 may transmit a PDU session establishment request message to the SMF 121. The SMF 121 may receive the PDU session establishment request message from the UE 101.

In an operation 217, the SMF 121 may transmit, to the UE 101, a PDU session establishment response message as a response to the PDU session establishment request message. The UE 101 may receive a PDU session establishment response message from the SMF 121.

In an operation 221:

### Embodiment 1

This embodiment includes a case in which the SMF 121 has configured the granularity of the network slice-related authentication, mobility, and session as a tracking area (Embodiment 1-A) or a registration area (Embodiment 1-B).

### Embodiment 1-A-1

For example, the SMF 121 may configure the granularity of authentication, mobility, or session related to a network slice to be used by the UE 101, in the unit of tracking area.

### Embodiment 1-A-2

For example, the SMF 121 may configure the granularity of authentication, mobility, or session associated with a network slice for use by the UE 101 in the unit of tracking area, and may store information about the tracking area, and authentication information about the tracking area. The information about the tracking area may include a TAC. For example, the SMF 121 may map NSSAI #1 to TAC #1, TAC #2, etc., and store the same together so as to identify which network slice (e.g., NSSAI #1) is provided from which tracking area (e.g., TAC #1, TAC #2, etc.).

### Embodiment 1-B

For example, the SMF 121 may configure the granularity of authentication, mobility, or sessions, which are associated with a network slice used by the UE 101, in the unit of registration area.

### Embodiment 2

This embodiment may correspond to a case in which the AMF 111 configures or configures and stores the granularity of authentication, mobility, or session associated with a network slice as a tracking area or registration area, the SMF 121 also configures the granularity of authentication, mobility, or session associated with a network slice as a tracking area or registration area based on the configuration information configured by the AMF 111.

### Embodiment 2-A-1

For example, in a case where the AMF 111 configures, in the unit of tracking area, the granularity of at least one of mobility or authentication associated with a network slice for use by the UE 101, the SMF 121 may configure the granularity of session or authentication associated with a network slice for use by the UE 101, in the unit of tracking area, based on the configuration information configured by the AMF 111.

### Embodiment 2-A-2

For example, in a case where the AMF 111 configures, in the unit of tracking area, the granularity of mobility or authentication associated with a network slice for use by the UE 101, and stores and manages a mutual mapping relationship between information about the tracking area and authentication information about the tracking area, the SMF 121 may configure the granularity of the authentication or session associated with a network slice for use by the UE 101, in the unit of tracking area, based on the information configured and stored by the AMF. The information about the tracking area may include a TAC.

### Embodiment 2-B

For example, in a case where the AMF 111 configures, in the unit of registration area, the granularity of mobility or authentication associated with a network slice for use by the UE 101, the SMF 121 may configure the granularity of session or authentication associated with the network slice for use by the UE 101, in the unit of registration area, by considering the configuration of the AMF 111.

In an operation 223, the SMF 121 may transmit an authentication request message to the AAA 181. The AAA 181 may receive the authentication request message from the SMF 121.

For example, the authentication request message may include at least one of an indication regarding the granularity (e.g., T in a case of managing in the unit of tracking area, R in a case of managing in the unit of registration area, etc.) to notify that the UE 101 is to use the network slice in the unit of tracking area, an indication of notifying that the UE 101 is using a network slice in the unit of tracking area (e.g., configuring a corresponding bit as 1 to indicate that the network slice is managed in the unit of tracking area), or associated tracking area information (e.g., TAC #1, TAC #2, TAC #3, etc.).

In an operation 225, the AAA 181 may configure the granularity of the network slice for use by the UE 101, in the unit of tracking area. For example, the AAA 181 may map a TAC and information about the network slice for use by the UE 101, or may bind, map, or store information of the network slice for use by the UE 101, network slice authentication information, a TAC, or location information of the UE 101.

In an operation 227, the AAA 181 may transmit an authentication response message to the SMF 121 as a response to the authentication request message. The authentication response message may include an indication notifying that the network to which the UE 101 is accessed has the capability of configuring supporting of the network slice in the unit of tracking area. The authentication response message may include an indication notifying that establishment, management, or authentication of the network slice are allowed in the unit of tracking area, or an indication (bit) for allowance thereof.

In an operation 231, the SMF 121 may transmit an authentication response message to the AMF 111.

For example, the authentication response message may include at least one of a list of tracking areas, information about a network slice available in the tracking area, and authentication information about whether the network slice is available in the tracking area.

In an operation 241, the AMF 111 may transmit an authentication request message to the UE 101.

For example, the authentication request message may include at least one of a list of tracking areas, information about a network slice available in the tracking area, and authentication information about whether the network slice is available in the tracking area.

In an operation 251, the UE 101 may store at least one of the list of tracking areas, information about a network slice available in the tracking area, and authentication information about the network slice, which are included in the authentication request message.

The stored information may include a list of TACs associated with the available network slices. For example, the stored information may include a list of available TACs that are authenticated or capable of providing a network slice service, a network slice, and information about network slice authentication per TAC.

The UE 101 may attempt access to the network based on the stored information during registration. For example, the UE 101 may attempt to establish and modify PDU sessions based on the stored information.

For example, the UE 101 may generate and transfer a movement management message of the UE such as a service request or a registration request message for movement or session management of the UE 101, or a session management message of the UE such as a PDU session establishment request message or a PDU session modification request, by using/including the stored list of tracking areas, information about the network slices available in the tracking area, and authentication information for the network slices.

For example, the UE 101 may identify a network slice, which is authenticated and allowed to access in the unit of TAC, based on the stored information so as to attempt to access, or may transmit at least one of a registration request message, a service request message, a PDU session establishment request message, and a PDU session modification request message to a network slice or a network that is able to provide network slice authentication in the unit of TAC.

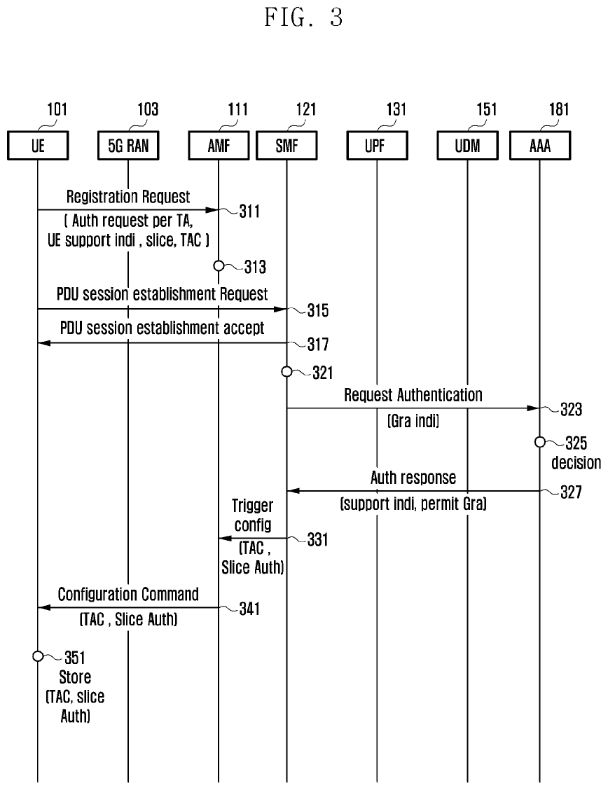

FIG. 3 illustrates a flow diagram of a procedure for providing communications to a UE 101 that is moving in a 5G network environment by considering network slices according to an embodiment of the present disclosure.

Referring to FIG. 3, in an operation 311, the UE 101 may transmit a registration request message to the AMF 111. For example, the registration request message may include at least one of the following information.

1) An indication (or information) for requesting the network to allow mobility tracking of the UE 101 in the unit of tracking area, register the location of the UE 101, and allow use and authentication of a network slice by the UE 101.

2) An indication for notifying the network that the UE 101 has the function of using and authenticating a slice in the unit of tracking area. This information includes information such as a bit or an indication notifying that the UE 101 has the capability of receiving authentication of a network slice in the unit of tracking area or performing communication using the corresponding authentication information.

3) Network slice information (e.g., network slice selection assistance information (NSSAI)) that the UE 101 uses to request service in the unit of tracking area: the NSSAI may include (a) a slice/service type (SST) requested by a user terminal or (b) a slice differentiator (SD) corresponding to the user terminal and the slice/service type. For example, network slice #1 (NSSAI #1), network slice #2 (NSSAI #2), etc.

4) Tracking area information which the UE 101 desires to request for services related to a slice, such as a tracking area code (TAC). For example, when requesting use and authentication of a network slice in the unit of tracking area from network slice #1, the UE 101 may transmit TAC information to the network (e.g., the AMF 111).

In an operation 313, the AMF 111 may configure the granularity of mobility or authentication associated with a network slice to be used by the UE 101, in the unit of tracking area, based on the registration request message received from the UE 101.

For example, in an embodiment (case 1), the AMF 111 may configure a network slice to be used by the UE 101 and the granularity of mobility or authentication associated with the slice in the unit of tracking area, and may store a mapping relationship between information about the tracking area and authentication information about the tracking area. The information about the tracking area may include a TAC. For example, the AMF 111 may map NSSAI #1, which is the network slice information, to TAC #1, which is the tracking area information, and map NSSAI #2, NSSAI #3, and the like to TAC #2, and may further store information relating to whether the UE 101 is allowed to use the corresponding network slice (a network slice identified by the NSSAI) in each TAC.

In another embodiment (case 2), the AMF 111 may configure the granularity of mobility and authentication associated with a network slice to be used by the UE 101 in the unit of registration area.

The AMF 111 may transmit, to the SMF 121 or to the AAA 181 via the SMF, at least one of an indication for the mobility granularity to notify that the UE 101 is to use a network slice in the unit of tracking area, an indication (or bit or information) indicating that the UE 101 is using a network slice in the unit of tracking area, or information related to a TAC. For example, at least one of the SMF 121 or the AAA 181 may receive, from the AMF 111, an indication for the mobility granularity to notify that the UE 101 is to use a network slice in the unit of tracking area, an indication (or bit or information) to indicate that the UE 101 is using a network slice in the unit of tracking area, or information related to the TAC.

In an operation 315, the UE 101 may transmit a PDU session establishment request message to the SMF 121. The SMF 121 may receive the PDU session establishment request message from the UE 101.

In an operation 317, the SMF 121 may transmit, to the UE 101, a PDU session establishment response message as a response to the PDU session establishment request message. The UE 101 may receive a PDU session establishment response message from the SMF 121.

In operation 321:

### Embodiment 1

This embodiment includes a case in which the SMF has configured the granularity of the network slice-related authentication, mobility, and session as a tracking area (Embodiment 1-A) or a registration area (Embodiment 1-B).

### Embodiment 1-A-1

For example, the SMF 121 may configure the granularity of authentication, mobility, or session related to a network slice to be used by the UE 101, in the unit of tracking area.

### Embodiment 1-A-2

For example, the SMF 121 may configure the granularity of authentication, mobility, or session associated with a network slice for use by the UE 101 in the unit of tracking area, and may store information about the tracking area, and authentication information about the tracking area. The information about the tracking area may include a TAC. For example, the SMF 121 may map NSSAI #1 to TAC #1, TAC #2, etc., and store the same together so as to identify which network slice (e.g., NSSAI #1) is provided from which tracking area (e.g., TAC #1, TAC #2, etc.).

### Embodiment 1-B

For example, the SMF 121 may configure the granularity of authentication, mobility, or session, which are associated with a network slice used by the UE 101, in the unit of registration area.

### Embodiment 2

This embodiment includes a case in which the AMF 111 configures or configures and stores the granularity of authentication, mobility, or sessions associated with a network slice, in the unit of tracking area or registration area, the SMF 121 also configures the granularity of authentication, mobility, or sessions associated with a network slice as a tracking area or registration area, based on the configuration information configured by the AMF 111.

### Embodiment 2-A-1

For example, in a case where the AMF 111 configures, in the unit of tracking area, the granularity of at least one of mobility or authentication associated with a network slice for use by the UE 101, the SMF 121 may configure the granularity of session or authentication associated with a network slice for use by the UE 101, in the unit of tracking area, based on the configuration information configured by the AMF 111.

### Embodiment 2-A-2

For example, in a case where the AMF 111 configures, in the unit of tracking area, the granularity of mobility or authentication associated with a network slice for use by the UE 101, and stores and manages a mutual mapping relationship between information about the tracking area and authentication information about the tracking area, the SMF 121 may configure the granularity of the authentication or session associated with a network slice for use by the UE 101, in the unit of tracking area, based on the information configured and stored by the AMF. The information about the tracking area may include a TAC.

### Embodiment 2-B

For example, in a case where the AMF 111 configures, in the unit of registration area, the granularity of mobility or authentication associated with a network slice for use by the UE 101, the SMF 121 may configure the granularity of session or authentication associated with a network slice for use by the UE 101, in the unit of registration area, by considering the configuration of the AMF 111.

In an operation 323, the SMF 121 may transmit an authentication request message to the AAA 181. The AAA 181 may receive the authentication request message from the SMF 121.

For example, the authentication request message may include at least one of an indication regarding the granularity (e.g., T in a case of managing in the unit of tracking area, R in a case of managing in the unit of registration area, etc.) to notify that the UE 101 is to use the network slice in the unit of tracking area, an indication of notifying that the UE 101 is using a network slice in the unit of tracking area (e.g., configuring a corresponding bit as 1 to indicate that the network slice is managed in the unit of tracking area), or associated tracking area information (e.g., TAC #1, TAC #2, TAC #3, etc.).

In an operation 325, the AAA 181 may configure the granularity of the network slice for use by the UE 101, in the unit of tracking area. For example, the AAA 181 may map a TAC and information about the network slice for use by the UE 101, or may bind, map, or store information of the network slice for use by the UE 101, network slice authentication information, a TAC, or location information of the UE 101.

In an operation 327, the AAA 181 may transmit an authentication response message to the SMF 121 as a response to the authentication request message. The authentication response message may include an indication notifying that the network to which the UE 101 is accessed has the capability of configuring supporting of the network slice in the unit of tracking area. The authentication response message may include an indication notifying that establishment, management, or authentication of the network slice are allowed in the unit of tracking area, or an indication (bit) for allowance thereof.

In an operation 331, the SMF 121 may transmit, to the AMF 111, a configuration trigger message that triggers the configuration setting.

For example, the configuration trigger message triggering the configuration setting may include at least one of a list of tracking areas, information about a network slice available in the tracking area, and authentication information about whether the network slice is available in the tracking area.

In operation an 341, the AMF 111 may transmit a configuration command message to the UE 101.

For example, the configuration command message may include at least one of a list of tracking areas, information about a network slice available in the tracking area, and authentication information about whether the network slice is available in the tracking area.

In an operation 351, the UE 101 may store at least one of the list of tracking areas, information about a network slice available in the tracking area, and authentication information about the network slice, which are included in the authentication request message.

The stored information may include a list of TACs associated with the available network slices. For example, the stored information may include a list of available TACs that are authenticated or capable of providing a network slice service, a network slice, and information about network slice authentication per TAC.

The UE 101 may attempt access to the network based on the stored information during registration. For example, the UE 101 may attempt to establish and modify PDU sessions based on the stored information.

For example, the UE 101 may generate and transfer a movement management message of the UE such as a service request or a registration request message for movement or session management of the UE 101, or a session management message of the UE such as a PDU session establishment request message or a PDU session modification request, by using/including the stored list of tracking areas, information about the network slices available in the tracking area, and authentication information for the network slices.

For example, the UE 101 may identify a network slice, which is authenticated and allowed access in the unit of TAC, based on the stored information so as to attempt to access, or may transmit at least one of a registration request message, a service request message, a PDU session establishment request message, and a PDU session modification request message to a network slice or a network that is able to provide network slice authentication in the unit of TAC.

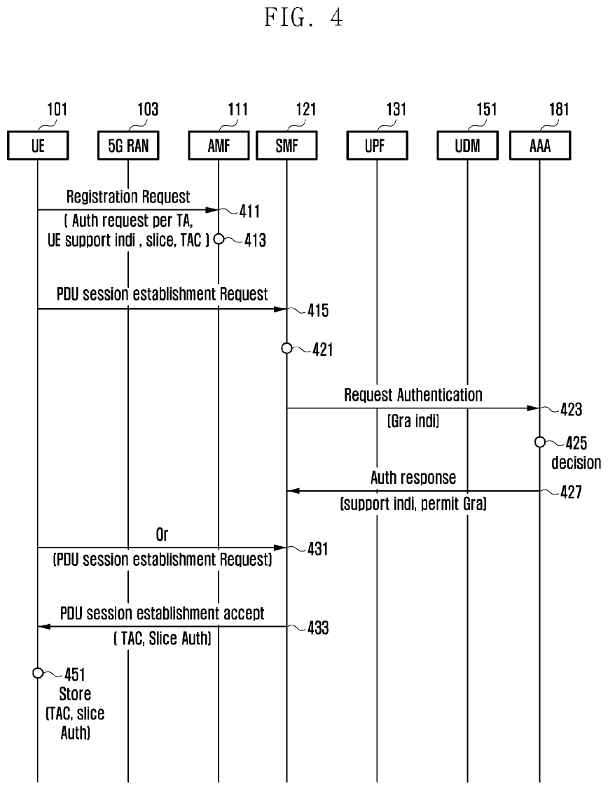

FIG. 4 illustrates a flow diagram of a procedure for providing communication to a UE 101 that is moving in a 5G network environment by considering network slices according to an embodiment of the present disclosure.

Referring to FIG. 4, in an operation 411, the UE 101 may transmit a registration request message to the AMF 111. For example, the registration request message may include at least one of the following pieces of information.

1) An indication (or information) for requesting the network to allow mobility tracking of the UE 101 in the unit of tracking area, register the location of the UE 101, and allow use and authentication of a network slice by the UE 101.

2) An indication for notifying the network that the UE 101 has the function of using and authenticating a slice in the unit of tracking area. This information includes information such as a bit or an indication notifying that the UE 101 has the capability of receiving authentication of a network slice in the unit of tracking area or performing communication using the corresponding authentication information

3) Network slice information (e.g., network slice selection assistance information (NSSAI)) that the UE 101 uses to request service in the unit of tracking area, NS SAI may include (a) a slice/service type (SST) requested by a user terminal or (b) a slice differentiator (SD) corresponding to the user terminal and the slice/service type. For example, network slice #1 (NSSAI #1), network slice #2 (NSSAI #2), etc.

4) Tracking area information which the UE 101 desires to request for services related to a slice, such as a tracking area code (TAC). For example, when requesting use and authentication of a network slice in the unit of tracking area from network slice #1, the UE 101 may transmit TAC information to the network (e.g., the AMF 111).

In an operation 413, the AMF 111 may configure the granularity of mobility or authentication associated with a network slice to be used by the UE 101, in the unit of tracking area, based on the registration request message received from the UE 101.

For example, in an embodiment (case 1), the AMF 111 may configure a network slice to be used by the UE 101 and the granularity of mobility or authentication associated with the slice in the unit of tracking area, and may store a mapping relationship between information about the tracking area and authentication information about the tracking area. The information about the tracking area may include a TAC. For example, the AMF 111 may map NSSAI #1, which is the network slice information, to TAC #1, which is the tracking area information, and map NSSAI #2, NSSAI #3, and the like to TAC #2, and may further store information relating to whether the UE 101 is allowed to use the corresponding network slice (a network slice identified by the NSSAI) in each TAC.

In another embodiment (case 2), the AMF 111 may configure the granularity of mobility and authentication associated with a network slice to be used by the UE 101, in the unit of registration area.

The AMF 111 may transmit, to the SMF 121 or to the AAA 181 via the SMF, at least one of an indication for the mobility granularity to notify that the UE 101 is to use a network slice in the unit of tracking area, an indication (or bit or information) indicating that the UE 101 is using a network slice in the unit of tracking area, or information related to a TAC. For example, at least one of the SMF 121 or the AAA 181 may receive, from the AMF 111, an indication for the mobility granularity to notify that the UE 101 is to use a network slice in the unit of tracking area, an indication (or bit or information) to indicate that the UE 101 is using a network slice in the unit of tracking area, or information related to the TAC.

In an operation 415, the UE 101 may transmit a PDU session establishment request message to the SMF 121. The SMF 121 may receive the PDU session establishment request message from the UE 101.

In another embodiment, a PDU session establishment request message may be transmitted from the UE 101 to the SMF 121 in an operation 431.

For example, the PDU session establishment request message may include the following information.

1) An indication (or information) for requesting the network to allow mobility tracking of the UE 101 in the unit of tracking area, register the location of the UE 101, and allow use and authentication of a network slice by the UE 101.

2) An indication for notifying the network that the UE 101 has the function of using and authenticating a slice in the unit of tracking area. This information includes information such as a bit or an indication notifying that the UE 101 has the capability of receiving authentication of a network slice in the unit of tracking area or performing communication using the corresponding authentication information.

3) Network slice information (e.g., network slice selection assistance information (NSSAI)) that the UE 101 uses to request service in the unit of tracking area. NSSAI may include (a) a slice/service type (SST) requested by a user terminal or (b) a slice differentiator (SD) corresponding to the user terminal and the slice/service type. Example: network slice #1 (NSSAI #1), network slice #2 (NSSAI #2), etc.

4) Tracking area information which the UE 101 desires to request for services related to a slice, such as a tracking area code (TAC). For example, when requesting use and authentication of a network slice in the unit of tracking area from network slice #1, the UE 101 may transmit TAC information to the network (e.g., the AMF 111).

In an operation 417, the SMF 121 may transmit, to the UE 101, a PDU session establishment response message as a response to the PDU session establishment request message. The UE 101 may receive a PDU session establishment response message from the SMF 121.

In an operation 421:

### Embodiment 1

This embodiment includes a case in which the SMF 121 has configured the granularity of the network slice-related authentication, mobility, and session as a tracking area (Embodiment 1-A) or a registration area (Embodiment 1-B).

### Embodiment 1-A-1

For example, the SMF 121 may configure the granularity of authentication, mobility, or session related to a network slice to be used by the UE 101, in the unit of tracking area.

### Embodiment 1-A-2

For example, the SMF 121 may configure the granularity of authentication, mobility, or session associated with a network slice for use by the UE 101 in the unit of tracking area, and may store information about the tracking area, and authentication information about the tracking area. The information about the tracking area may include a TAC. For example, the SMF 121 may map NSSAI #1 to TAC #1, TAC #2, etc., and store the same together so as to identify which network slice (e.g., NSSAI #1) is provided from which tracking area (e.g., TAC #1, TAC #2, etc.).

### Embodiment 1-B

For example, the SMF 121 may configure the granularity of authentication, mobility, or session, which are associated with a network slice used by the UE 101, in the unit of registration area.

### Embodiment 2

This embodiment includes a case in which the AMF 111 configures or configures and stores the granularity of authentication, mobility, or sessions associated with a network slice, in the unit of tracking area or registration area, the SMF 121 also configures the granularity of authentication, mobility, or sessions associated with a network slice as a tracking area or registration area, based on the configuration information configured by the AMF 111.

### Embodiment 2-A-1

For example, in a case where the AMF 111 configures, in the unit of tracking area, the granularity of at least one of mobility or authentication associated with a network slice for use by the UE 101, the SMF 121 may configure the granularity of session or authentication associated with a network slice for use by the UE 101, in the unit of tracking area, based on the configuration information configured by the AMF 111.

### Embodiment 2-A-2

For example, in a case where the AMF 111 configures, in the unit of tracking area, the granularity of mobility or authentication associated with a network slice for use by the UE 101, and stores and manages a mutual mapping relationship between information about the tracking area and authentication information about the tracking area, the SMF 121 may configure the granularity of the authentication or session associated with a network slice for use by the UE 101, in the unit of tracking area, based on the information configured and stored by the AMF. The information about the tracking area may include a TAC.

### Embodiment 2-B

For example, in a case where the AMF 111 configures, in the unit of registration area, the granularity of mobility or authentication associated with a network slice for use by the UE 101, the SMF 121 may configure the granularity of session or authentication associated with a network slice for use by the UE 101, in the unit of registration area, by considering the configuration of the AMF 111.

In an operation 423, the SMF 121 may transmit an authentication request message to the AAA 181. The AAA 181 may receive the authentication request message from the SMF 121.

For example, the authentication request message may include at least one of an indication regarding the granularity (e.g., T in a case of managing in the unit of tracking area, R in a case of managing in the unit of registration area, etc.) to notify that the UE 101 is to use the network slice in the unit of tracking area, an indication of notifying that the UE 101 is using a network slice in the unit of tracking area (e.g., configuring a corresponding bit as 1 to indicate that the network slice is managed in the unit of tracking area), or associated tracking area information (e.g., TAC #1, TAC #2, TAC #3, etc.).

In an operation 425, the AAA 181 may configure the granularity of the network slice for use by the UE 101, in the unit of tracking area. For example, the AAA 181 may map a TAC and information about the network slice for use by the UE 101, or may bind, map, or store information of the network slice for use by the UE 101, network slice authentication information, a TAC, or location information of the UE 101.

In an operation 427, the AAA 181 may transmit an authentication response message to the SMF 121 as a response to the authentication request message. The authentication response message may include an indication notifying that the network to which the UE 101 is accessed has the capability of configuring supporting of the network slice in the unit of tracking area. The authentication response message may include an indication notifying that establishment, management, or authentication of the network slice are allowed in the unit of tracking area, or an indication (bit) for allowance thereof.

In an operation 433, the SMF 121 may transmit a PDU session establishment accept message to the UE 101.

For example, the PDU session establishment accept message may include at least one of a list of tracking areas, information about a network slice available in the tracking area, and authentication information about whether the network slice is available in the tracking area.

In an operation 451, the UE 101 may store at least one of the list of tracking areas, information about a network slice available in the tracking area, and authentication information about the network slice, which are included in the PDU session establishment accept message.

The stored information may include a list of TACs associated with the available network slices. For example, the stored information may include a list of available TACs that are authenticated or capable of providing a network slice service, a network slice, and information about network slice authentication per TAC.

The UE 101 may attempt access to the network based on the stored information during registration. For example, the UE 101 may attempt to establish and modify PDU sessions based on the stored information.

For example, the UE 101 may generate and transfer a movement management message of the UE such as a service request or a registration request message for movement or session management of the UE 101, or a session management message of the UE such as a PDU session establishment request message or a PDU session modification request, by using/including the stored list of tracking areas, information about the network slices available in the tracking area, and authentication information for the network slices.

For example, the UE 101 may identify a network slice, which is authenticated and allowed access in the unit of TAC, based on the stored information so as to attempt to access, or may transmit at least one of a registration request message, a service request message, a PDU session establishment request message, and a PDU session modification request message to a network slice or a network that is able to provide network slice authentication in the unit of TAC.

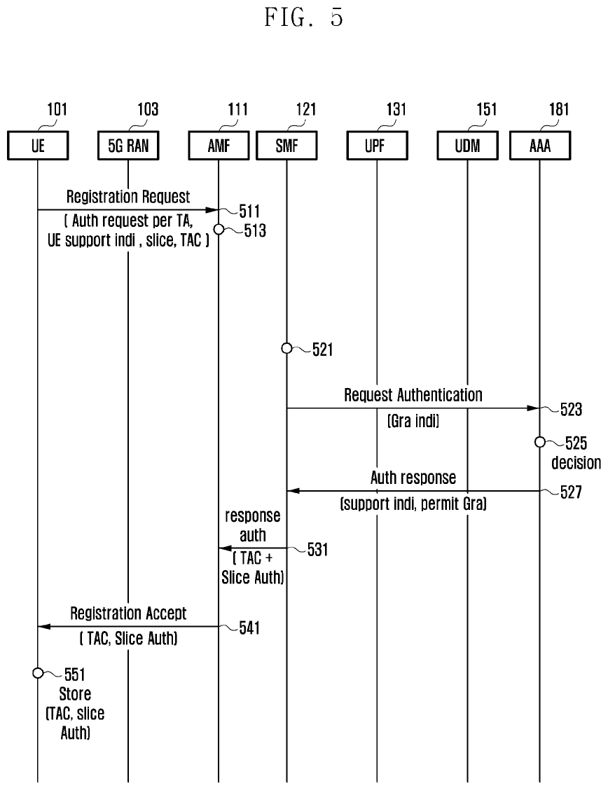

FIG. 5 illustrates a flow diagram of a procedure for providing communication to a UE 101 that is moving in a 5G network environment by considering network slices according to an embodiment of the present disclosure.

Referring to FIG. 5, in an operation 511, the UE 101 may transmit a registration request message to the AMF 111. For example, the registration request message may include at least one of the following pieces of information.

1) An indication (or information) for requesting the network to allow mobility tracking of the UE 101 in the unit of tracking area, register the location of the UE 101, and allow use and authentication of a network slice by the UE 101.

2) An indication for notifying the network that the UE 101 has the function of using and authenticating a slice in the unit of tracking area. This information includes information such as a bit or an indication notifying that the UE 101 has the capability of receiving authentication of a network slice in the unit of tracking area or performing communication using the corresponding authentication information.

3) Network slice information (e.g., network slice selection assistance information (NSSAI)) that the UE 101 uses to request service in the unit of tracking area. NSSAI may include (a) a slice/service type (SST) requested by a user terminal or (b) a slice differentiator (SD) corresponding to the user terminal and the slice/service type. For example, network slice #1 (NSSAI #1), network slice #2 (NSSAI #2), etc.

4) Tracking area information which the UE 101 desires to request for services related to a slice, such as a tracking area code (TAC). For example, when requesting use and authentication of a network slice in the unit of tracking area from network slice #1, the UE 101 may transmit TAC information to the network (e.g., the AMF 111).

In an operation 513, the AMF 111 may configure the granularity of mobility or authentication associated with a network slice to be used by the UE 101, in the unit of tracking area, based on the registration request message received from the UE 101.

For example, in an embodiment (case 1), the AMF 111 may configure a network slice to be used by the UE 101 and the granularity of mobility or authentication associated with the slice in the unit of tracking area, and may store a mapping relationship between information about the tracking area and authentication information about the tracking area. The information about the tracking area may include a TAC. For example, the AMF 111 may map NSSAI #1, which is the network slice information, to TAC #1, which is the tracking area information, and map NSSAI #2, NSSAI #3, and the like to TAC #2, and may further store information relating to whether the UE 101 is allowed to use the corresponding network slice (a network slice identified by the NSSAI) in each TAC.

In another embodiment (case 2), the AMF 111 may configure the granularity of mobility and authentication associated with a network slice to be used by the UE 101 in the unit of registration area.

The AMF 111 may transmit, to the SMF 121 or to the AAA 181 via the SMF, at least one of an indication for the mobility granularity to notify that the UE 101 is to use a network slice in the unit of tracking area, an indication (or bit or information) indicating that the UE 101 is using a network slice in the unit of tracking area, or information related to a TAC. For example, at least one of the SMF 121 or the AAA 181 may receive, from the AMF 111, an indication for the mobility granularity to notify that the UE 101 is to use a network slice in the unit of tracking area, an indication (or bit or information) to indicate that the UE 101 is using a network slice in the unit of tracking area, or information related to the TAC.

In an operation 515, the UE 101 may transmit a PDU session establishment request message to the SMF 121. The SMF 121 may receive the PDU session establishment request message from the UE 101.

In an operation 517, the SMF 121 may transmit, to the UE 101, a PDU session establishment response message as a response to the PDU session establishment request message. The UE 101 may receive a PDU session establishment response message from the SMF 121.

In an operation 521:

### Embodiment 1

This embodiment includes a case in which the SMF 121 has configured the granularity of the network slice-related authentication, mobility, and session as a tracking area (Embodiment 1-A) or a registration area (Embodiment 1-B).

### Embodiment 1-A-1

For example, the SMF 121 may configure the granularity of authentication, mobility, or session related to a network slice to be used by the UE 101, in the unit of tracking area.

### Embodiment 1-A-2

For example, the SMF 121 may configure the granularity of authentication, mobility, or session associated with a network slice for use by the UE 101 in the unit of tracking area, and may store information about the tracking area, and authentication information about the tracking area. The information about the tracking area may include a TAC. For example, the SMF 121 may map NSSAI #1 to TAC #1, TAC #2, etc., and store the same together so as to identify which network slice (e.g., NSSAI #1) is provided from which tracking area (e.g., TAC #1, TAC #2, etc.).

### Embodiment 1-B

For example, the SMF 121 may configure the granularity of authentication, mobility, or session, which are associated with a network slice used by the UE 101, in the unit of registration area.

### Embodiment 2

This embodiment includes a case in which the AMF 111 configures or configures and stores the granularity of authentication, mobility, or sessions associated with a network slice, in the unit of tracking area or registration area, the SMF 121 also configures the granularity of authentication, mobility, or sessions associated with a network slice as a tracking area or registration area, based on the configuration information configured by the AMF 111.

### Embodiment 2-A-1

For example, in a case where the AMF 111 configures, in the unit of tracking area, the granularity of at least one of mobility or authentication associated with a network slice for use by the UE 101, the SMF 121 may configure the granularity of session or authentication associated with a network slice for use by the UE 101, in the unit of tracking area, based on the configuration information configured by the AMF 111.

### Embodiment 2-A-2

For example, in a case where the AMF 111 configures, in the unit of tracking area, the granularity of mobility or authentication associated with a network slice for use by the UE 101, and stores and manages a mutual mapping relationship between information about the tracking area and authentication information about the tracking area, the SMF 121 may configure the granularity of the authentication or session associated with a network slice for use by the UE 101, in the unit of tracking area, based on the information configured and stored by the AMF. The information about the tracking area may include a TAC.

### Embodiment 2-B

For example, in a case where the AMF 111 configures, in the unit of registration area, the granularity of mobility or authentication associated with a network slice for use by the UE 101, the SMF 121 may configure the granularity of session or authentication associated with a network slice for use by the UE 101, in the unit of registration area, by considering the configuration of the AMF 111.

In an operation 523, the SMF 121 may transmit an authentication request message to the AAA 181. The AAA 181 may receive the authentication request message from the SMF 121.

For example, the authentication request message may include at least one of an indication regarding the granularity (e.g., T in a case of managing in the unit of tracking area, R in a case of managing in the unit of registration area, etc.) to notify that the UE 101 is to use the network slice in the unit of tracking area, an indication of notifying that the UE 101 is using a network slice in the unit of tracking area (e.g., configuring a corresponding bit as 1 to indicate that the network slice is managed in the unit of tracking area), or associated tracking area information (e.g., TAC #1, TAC #2, TAC #3, etc.).

In an operation 525, the AAA 181 may configure the granularity of the network slice for use by the UE 101, in the unit of tracking area. For example, the AAA 181 may map a TAC and information about the network slice for use by the UE 101, or may bind, map, or store information of the network slice for use by the UE 101, network slice authentication information, a TAC, or location information of the UE 101.

In an operation 527, the AAA 181 may transmit an authentication response message to the SMF 121 as a response to the authentication request message. The authentication response message may include an indication notifying that the network to which the UE 101 is accessed has the capability of configuring supporting of the network slice in the unit of tracking area. The authentication response message may include an indication notifying that establishment, management, or authentication of the network slice are allowed in the unit of tracking area, or an indication (bit) for allowance thereof.

In an operation 531, the SMF 121 may transmit an authentication response message to the AMF 111.

For example, the authentication response message may include at least one of a list of tracking areas, information about a network slice available in the tracking area, and authentication information about whether the network slice is available in the tracking area.

In an operation 541, the AMF 111 may transmit a registration accept message to the UE 101.

For example, the registration accept message may include at least one of a list of tracking areas, information about a network slice available in the tracking area, and authentication information about whether the network slice is available in the tracking area.

In an operation 551, the UE 101 may store at least one of the list of tracking areas, information about a network slice available in the tracking area, and authentication information about the network slice, which are included in the authentication request message.

The stored information may include a list of TACs associated with the available network slices. For example, the stored information may include a list of available TACs that are authenticated or capable of providing a network slice service, a network slice, and information about network slice authentication per TAC.

The UE 101 may attempt access to the network based on the stored information during registration. For example, the UE 101 may attempt to establish and modify PDU sessions based on the stored information.

For example, the UE 101 may generate and transfer a movement management message of the UE such as a service request or a registration request message for movement or session management of the UE 101, or a session management message of the UE such as a PDU session establishment request message or a PDU session modification request, by using/including the stored list of tracking areas, information about the network slices available in the tracking area, and authentication information for the network slices.

For example, the UE 101 may identify a network slice, which is authenticated and allowed access in the unit of TAC, based on the stored information so as to attempt to access, or may transmit at least one of a registration request message, a service request message, a PDU session establishment request message, and a PDU session modification request message to a network slice or a network that is able to provide network slice authentication in the unit of TAC.

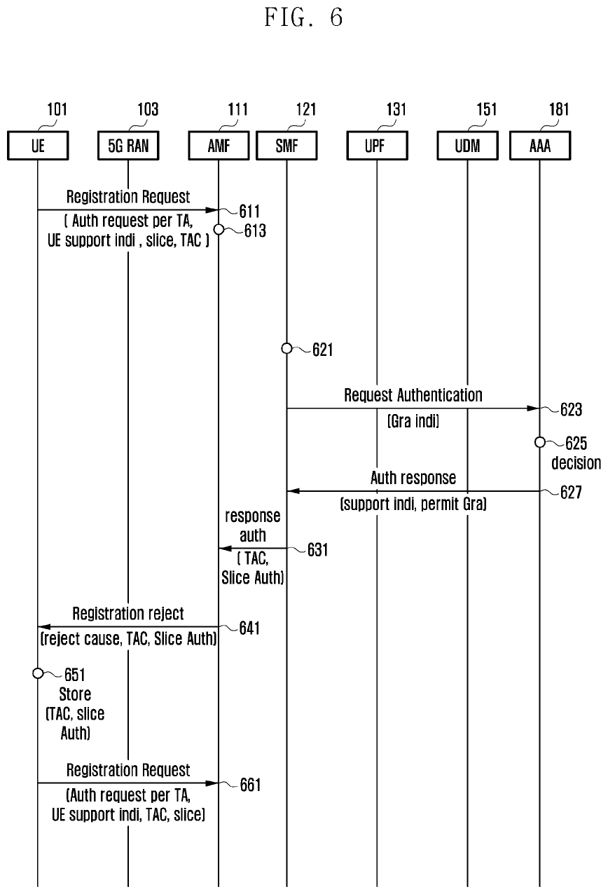

FIG. 6 illustrates a flow diagram of a procedure for providing communication to a UE 101 that is moving in a 5G network environment by considering network slices according to an embodiment of the present disclosure.

Referring to FIG. 6, in an operation 611, the UE 101 may transmit a registration request message to the AMF 111. For example, the registration request message may include at least one of the following pieces of information.

1) An indication (or information) for requesting the network to allow mobility tracking of the UE 101 in the unit of tracking area, register the location of the UE 101, and allow use and authentication of a network slice by the UE 101.

2) An indication for notifying the network that the UE 101 has the function of using and authenticating a slice in the unit of tracking area. This information includes information such as a bit or an indication notifying that the UE 101 has the capability of receiving authentication of a network slice in the unit of tracking area or performing communication using the corresponding authentication information.

3) Network slice information (e.g., network slice selection assistance information (NSSAI)) that the UE 101 uses to request service in the unit of tracking area. NS SAI may include (a) a slice/service type (SST) requested by a user terminal or (b) a slice differentiator (SD) corresponding to the user terminal and the slice/service type. For example, network slice #1 (NSSAI #1), network slice #2 (NSSAI #2), etc.

4) Tracking area information which the UE 101 desires to request for services related to a slice, such as a tracking area code (TAC). For example, when requesting use and authentication of a network slice in the unit of tracking area from network slice #1, the UE 101 may transmit TAC information to the network (e.g., the AMF 111).

In an operation 613, the AMF 111 may configure the granularity of mobility or authentication associated with a network slice to be used by the UE 101, in the unit of tracking area, based on the registration request message received from the UE 101.

For example, in an embodiment (case 1), the AMF 111 may configure a network slice to be used by the UE 101 and the granularity of mobility or authentication associated with the slice in the unit of tracking area, and may store a mapping relationship between information about the tracking area and authentication information about the tracking area. The information about the tracking area may include a TAC. For example, the AMF 111 may map NSSAI #1, which is the network slice information, to TAC #1, which is the tracking area information, and map NSSAI #2, NSSAI #3, and the like to TAC #2, and may further store information relating to whether the UE 101 is allowed to use the corresponding network slice (a network slice identified by the NSSAI) in each TAC.

In another embodiment (case 2), the AMF 111 may configure the granularity of mobility and authentication associated with a network slice to be used by the UE 101 in the unit of registration area.

The AMF 111 may transmit, to the SMF 121 or to the AAA 181 via the SMF, at least one of an indication for the mobility granularity to notify that the UE 101 is to use a network slice in the unit of tracking area, an indication (or bit or information) indicating that the UE 101 is using a network slice in the unit of tracking area, or information related to a TAC. For example, at least one of the SMF 121 or the AAA 181 may receive, from the AMF 111, an indication for the mobility granularity to notify that the UE 101 is to use a network slice in the unit of tracking area, an indication (or bit or information) to indicate that the UE 101 is using a network slice in the unit of tracking area, or information related to the TAC.

In an operation 615, the UE 101 may transmit a PDU session establishment request message to the SMF 121. The SMF 121 may receive the PDU session establishment request message from the UE 101.

In an operation 617, the SW′ 121 may transmit, to the UE 101, a PDU session establishment response message as a response to the PDU session establishment request message. The UE 101 may receive a PDU session establishment response message from the SMF 121.

In an operation 621:

### Embodiment 1

This embodiment includes a case in which the SMF 121 has configured the granularity of the network slice-related authentication, mobility, and session as a tracking area (Embodiment 1-A) or a registration area (Embodiment 1-B).

### Embodiment 1-A-1

For example, the SMF 121 may configure the granularity of authentication, mobility, or session related to a network slice to be used by the UE 101, in the unit of tracking area.

### Embodiment 1-A-2

For example, the SMF 121 may configure the granularity of authentication, mobility, or session associated with a network slice for use by the UE 101 in the unit of tracking area, and may store information about the tracking area, and authentication information about the tracking area. The information about the tracking area may include a TAC. For example, the SMF 121 may map NSSAI #1 to TAC #1, TAC #2, etc., and store the same together so as to identify which network slice (e.g., NSSAI #1) is provided from which tracking area (e.g., TAC #1, TAC #2, etc.).

### Embodiment 1-B

For example, the SMF 121 may configure the granularity of authentication, mobility, or session, which are associated with a network slice used by the UE 101, in the unit of registration area.

### Embodiment 2

This embodiment includes a case in which the AMF 111 configures or configures and stores the granularity of authentication, mobility, or sessions associated with a network slice, in the unit of tracking area or registration area, the SMF 121 also configures the granularity of authentication, mobility, or sessions associated with a network slice as a tracking area or registration area, based on the configuration information configured by the AMF 111.

### Embodiment 2-A-1

For example, in a case where the AMF 111 configures, in the unit of tracking area, the granularity of at least one of mobility or authentication associated with a network slice for use by the UE 101, the SMF 121 may configure the granularity of session or authentication associated with a network slice for use by the UE 101, in the unit of tracking area, based on the configuration information configured by the AMF 111.

### Embodiment 2-A-2

For example, in a case where the AMF 111 configures, in the unit of tracking area, the granularity of mobility or authentication associated with a network slice for use by the UE 101, and stores and manages a mutual mapping relationship between information about the tracking area and authentication information about the tracking area, the SMF 121 may configure the granularity of the authentication or session associated with a network slice for use by the UE 101, in the unit of tracking area, based on the information configured and stored by the AMF. The information about the tracking area may include a TAC.

### Embodiment 2-B

For example, in a case where the AMF 111 configures, in the unit of registration area, the granularity of mobility or authentication associated with a network slice for use by the UE 101, the SMF 121 may configure the granularity of session or authentication associated with a network slice for use by the UE 101, in the unit of registration area, by considering the configuration of the AMF 111.

In an operation 623, the SMF 121 may transmit an authentication request message to the AAA 181. The AAA 181 may receive the authentication request message from the SMF 121.

For example, the authentication request message may include at least one of an indication regarding the granularity (e.g., T in a case of managing in the unit of tracking area, R in a case of managing in the unit of registration area, etc.) to notify that the UE 101 is to use the network slice in the unit of tracking area, an indication of notifying that the UE 101 is using a network slice in the unit of tracking area (e.g., configuring a corresponding bit as 1 to indicate that the network slice is managed in the unit of tracking area), or associated tracking area information (e.g., TAC #1, TAC #2, TAC #3, etc.).

In an operation 625, the AAA 181 may configure the granularity of the network slice for use by the UE 101, in the unit of tracking area. For example, the AAA 181 may map a TAC and information about the network slice for use by the UE 101, or may bind, map, or store information of the network slice for use by the UE 101, network slice authentication information, a TAC, or location information of the UE 101.

In an operation 627, the AAA 181 may transmit an authentication response message to the SMF 121 as a response to the authentication request message. The authentication response message may include an indication notifying that the network to which the UE 101 is accessed has the capability of configuring supporting of the network slice in the unit of tracking area. The authentication response message may include an indication notifying that establishment, management, or authentication of the network slice are allowed in the unit of tracking area, or an indication (bit) for allowance thereof.

In an operation 631, the SMF 121 may transmit an authentication response message to the AMF 111.

For example, the authentication response message may include at least one of a list of tracking areas, information about a network slice available in the tracking area, and authentication information about whether the network slice is available in the tracking area.

In an operation 641, the AMF 111 may transmit a registration rejection message to the UE 101.

### Embodiment 6-A)

Network slice information that can be authenticated/available in the unit of tracking area (TAC-available network slice information).

For example, the registration rejection message may include information of a network slice (TAC-available network slice) that the UE 101 is able to authenticate/use in the unit of tracking area.

The TAC-available network slice information that the UE 101 is able to authenticate/use in the unit of tracking area may include at least one of the following pieces of information.

1) Information of network slices that are authenticated or permitted for use in the unit of tracking area (e.g., network slice information that is authenticated or permitted for use in the corresponding TAC, NSSAI, etc.).

2) A list of relevant tracking area codes (TAC), tracking area information, or a tracking area list.

3) Authentication information about whether the corresponding network slice is available in the tracking area.

Thereafter, the UE 101 may attempt to access a network by using network slice information that can be accessed/authenticated in the TAC in a subsequent registration attempt. Alternatively, the UE 101 may attempt to establish or modify a session by using network slice information that can be accessed/authenticated in the TAC in a subsequent PDU session establishment/modification attempt.

In an embodiment, in a case where the UE 101 receives network slice (TAC-available network slice) information that can be authenticated/available in the unit of tracking area, through a registration reject/or registration accept message after attempting registration,

1) The UE 101 may add the corresponding TAC or the corresponding network slice to the authenticable/available network slice (TAC-available network slice) information and store the same in a SIM/non-volatile/volatile memory.

2) The UE 101 may then attempt subsequent access to the stored TAC or network slice in the authenticable/available network slice (TAC-available network slice) information.

3) Further, in a case where the UE 101 fails a subsequent registration process for the TAC or network slice included or stored in the authenticable/available network slice (TAC-available network slice), the TAC or network slice may be removed from the list of authenticated/available network slice (TAC-available network slice) information.

4) In addition, the list may be stored until the UE is switched off or a SIM is removed. Alternatively, the list may be deleted when the UE is switched off or the SIM is removed. Alternatively, the list may be updated after a predetermined period of time.

### Embodiment 6-B)

Network slice (TAC-forbidden network slice) information that cannot be authenticated/available in the unit of tracking area, or is not permitted.

For example, the registration rejection message may include network slice (TAC-forbidden network slice) information that the UE 101 is unable to authenticate/use in the unit of tracking area, or that is not permitted.

Alternatively, although the UE 101 attempts to use and authenticate network slice information in the unit of tracking area, and the same is not permitted, the UE 101 may store the corresponding information in the network slice information that cannot be authenticated/available, or is not permitted (TAC-forbidden network slice).

The TAC-forbidden network slice information that the UE 101 is unable to authenticate/use in the unit of tracking area, or that is not permitted may include at least one of the following pieces of information.

1) List of tracking area codes (TACs), tracking area information, or tracking area list.

2) Information about the network slices that are unavailable in the unit of tracking area (for example, network slice information, NSSAI, etc. that are not permitted for use in the corresponding TAC).

3) Information of network slices that are not authenticated in the unit of tracking area, cannot be authenticated, or attempted to be authenticated but failed (e.g., network slice information, NSSAI, etc. that failed to be authenticated in the corresponding TAC).

4) Authentication information relating to whether the network slice is available in the tracking area.

5) Information about the cause for rejection.

### Embodiment 1 Relating to Cause for Rejection: Cause #xx)

For example, the information about the cause for rejection may be “information/cause value/or indication indicating that authentication for the network slice cannot be supported in the unit of tracking area.” For example, the information about the cause for the rejection may include cause value xx. For example, cause value xx may indicate that authentication to the network slice cannot be supported in the unit of tracking area. For example, the UE 101 may determine that the network is unable to support authentication for the network slice in the unit of tracking area, based on the registration rejection message including information about the cause for the rejection.

### Embodiment 2 Relating to Cause for Rejection: Cause #Yy)

The information about the cause for the rejection may be “information/cause value/or indication relating to a case in which authentication to the network slice has been attempted in the unit of tracking area but failed.” For example, the information about the cause for the rejection may include the cause value yy. For example, the cause value yy may indicate that authentication to the network slice has been attempted in the unit of tracking area but failed. For example, the UE 101 may determine, based on the registration rejection message including information about the cause for the rejection, that the network attempted to authenticate to the network slice in the unit of tracking area but failed to authenticate the network slice in the corresponding tracking area.

In an embodiment, in case that the UE 101 receives, through the registration reject/or registration accept message, “information/cause value/or indication indicating that authentication for the network slice cannot be supported in the unit of tracking area” (cause #xx), as a registration/access result, after a registration attempt, the UE 101 may add the network slice information, TAC information, etc. to the list of network slices that are unable to be authenticated/used or not permitted (TAC-forbidden network slices) in the unit of tracking area and store the same in SIM/non-volatile/volatile memory.

The UE 101 may not subsequently attempt to register/access to the stored list of network slices that are unable to be authenticated/used or not permitted (TAC-forbidden network slices) in the unit of tracking area.

In addition, in case that the UE 101 subsequently succeeds in the registration process for the TAC and network slice stored in the list of network slices that are unable to be authenticated/used in the unit of tracking area or not permitted (TAC-forbidden network slices), the TAC and network slice may be removed from the TAC-forbidden network slice list in the unit of tracking area.

Further, the list may be stored until the UE 101 is switched off or the SIM is removed. Alternatively, the list may be deleted when the UE 101 is switched off or the SIM is removed. Alternatively, the list may be updated after a predetermined period of time.

In an embodiment, in a case where the UE 101 receives, in the registration reject/or registration accept message, “information/cause value/or indication indicating authentication attempted to the network slice in the unit of tracking area but failed (cause #yy),

1) This PLMN may be stored in a list of network slices that are unable to be authenticated/used in the unit of tracking area for the network slice service or not permitted (TAC-forbidden network slices).

2) Further, the UE 101 may not subsequently attempt to register/access network slices that are unable to be authenticated/used in the unit of tracking area or not permitted (TAC-forbidden network slices).

3) After a registration process has been successfully performed, the corresponding network slice information and TAC information may be deleted from the list of network slices that are unable to be authenticated/used in the unit of tracking area or not permitted (TAC-forbidden network slices).

4) This list is deleted when the UE 101 is switched off or the SIM is removed. Alternatively, this list may be updated after a predetermined period of time.

Thereafter, the UE 101 may attempt to register/access a network during the registration phase, excluding network slices as indicated by the information included in the registration rejection message, or excluding TACs that do not support the network slice. For example, the UE 101 may perform operation of establishing a PDU session or modifying a PDU session, excluding the network slices indicated by the registration rejection message, or excluding TACs that do not support the network slices.

In an operation 651, the UE 101 may store at least one of the list of tracking areas, information about a network slice available in the tracking area, and authentication information about the network slice, which are included in the authentication request message.

The stored information may include a list of TACs associated with available network slices. For example, the stored information may include a list of available TACs that are authenticated or capable of providing a network slice service, a network slice, and information about network slice authentication per TAC.

The UE 101 may attempt access to a network based on the stored information during registration. For example, the UE 101 may attempt to establish and modify PDU sessions based on the stored information.

For example, the UE 101 may generate and transfer a movement management message of the UE such as a service request or a registration request message for movement or session management of the UE 101, or a session management message of the UE such as a PDU session establishment request message or a PDU session modification request, by using/including the stored list of tracking areas, information about the network slices available in the tracking area, and authentication information for the network slices.

For example, the UE 101 may identify a network slice, which is authenticated and allowed access in the unit of TAC, based on the stored information so as to attempt to access, or may transmit at least one of a registration request message, a service request message, a PDU session establishment request message, and a PDU session modification request message to a network slice or a network that is able to provide network slice authentication in the unit of TAC.

In an operation 661, the UE 101 may transmit a second registration request message to the AMF 111 through the RAN 103.

For example, the registration request message may include at least one of the following pieces of information.

1) An indication (or information) for requesting the network to allow mobility tracking of the UE 101 in the unit of tracking area, register the location of the UE 101, and allow use and authentication of a network slice by the UE 101.

2) An indication for notifying the network that the UE 101 has the function of using and authenticating a slice in the unit of tracking area. This information includes information such as a bit or an indication notifying that the UE 101 has the capability of receiving authentication of a network slice in the unit of tracking area or performing communication using the corresponding authentication information.

3) Network slice information (e.g., network slice selection assistance information (NSSAI)) that the UE 101 uses to request service in the unit of tracking area. NS SAI may include (a) a slice/service type (SST) requested by a user terminal or (b) Slice differentiator (SD) corresponding to the user terminal and the slice/service type. For example, network slice #1 (NSSAI #1), network slice #2 (NSSAI #2), etc.

4) Tracking area information which the UE 101 desires to request for services related to a slice, such as a tracking area code (TAC). For example, when requesting use and authentication of a network slice in the unit of tracking area from network slice #1, the UE 101 may transmit TAC information to the network (e.g., the AMF 111).

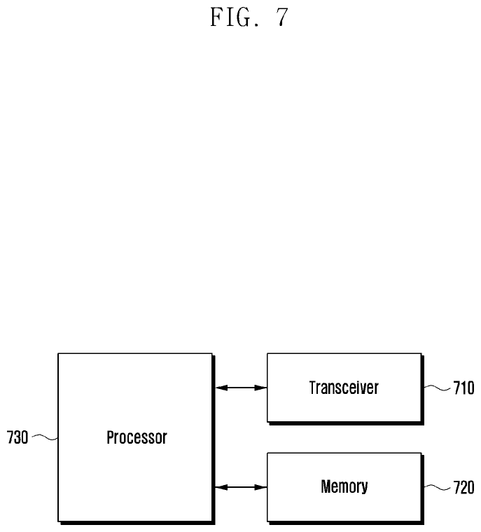

FIG. 7 is a block diagram illustrating a configuration of a UE 101 according to the disclosure.

As shown in FIG. 7, the UE 101 of the disclosure may include a transceiver 710, a memory 720, and a processor 730. The processor 730, the transceiver 710, and the memory 720 of the UE 101 may operate according to the communication method of the UE 101 described above. However, the elements of the UE 101 are not limited to the above examples. For example, the UE 101 may include more elements or fewer elements than those described above. Furthermore, the processor 730, transceiver 710, and memory 720 may be implemented in the form of a single chip.

The transceiver 710, collectively referred to as including a receiver of the UE 101 and a transmitter of the UE 101, may transmit or receive signals to and from the base station 103 or the network entities 111, 121, 131, 151, and 181. The signals transmitted to or received from the base station 103 may include control information and data. To this end, the transceiver 710 may include an RF transmitter configured to up-convert and amplify the frequency of the transmitted signal, and an RF receiver configured to low-noise amplify and down-convert the frequency of the received signal. However, this is only an embodiment of the transceiver 710, and the elements of the transceiver 710 are not limited to the RF transmitter and RF receiver.

Further, the transceiver 710 may include a wired or wireless transceiver, and may include various configurations for transmitting and receiving signals.

In addition, the transceiver 710 may receive signals through a wireless channel and output the signals to the processor 730, and transmit the signals output from the processor 730 through the wireless channel.

In addition, the transceiver 710 may receive communication signals and output the communication signals to the processor, and transmit the signals output from the processor to a network entity via a wired or wireless network.

The memory 720 may store programs and data required for operation of the UE 101. In addition, the memory 720 may store control information or data included in signals acquired by the terminal. The memory 720 may include a storage medium, such as a ROM, RAM, hard disk, CD-ROM, and DVD, or a combination of storage media.

The processor 730 may control a series of processes to enable the UE 101 to operate according to the embodiments of the disclosure described above. The processor 730 may include at least one processor. For example, the processor 730 may include a communication processor (CP) configured to perform control for communication and an application processor (AP) configured to control a higher layer such as applications.

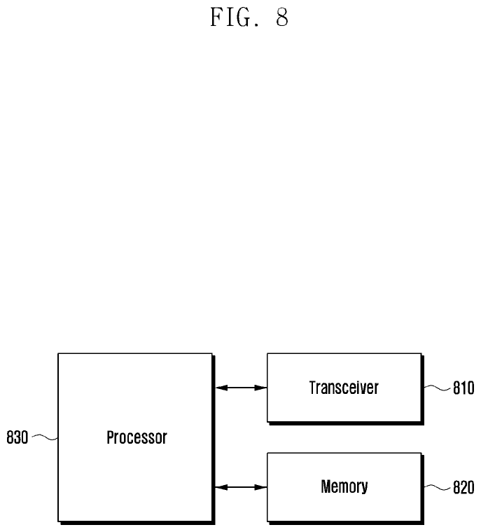

FIG. 8 illustrates a configuration of network entities 103, 111, 121, 131, 151, and 181 according to the disclosure.

As shown in FIG. 8, the network entities 103, 111, 121, 131, 151, and 181 of the disclosure may include a transceiver 810, a memory 820, and a processor 830. The processor 830, the transceiver 810, and the memory 820 of the network entities 103, 111, 121, 131, 151, 181 may operate according to the communication methods of the network entities 103, 111, 121, 131, 151, and 181 described above. However, the elements of the network entities 103, 111, 121, 131, 151, and 181 are not limited to the foregoing examples. For example, the network entities 103, 111, 121, 131, 151, and 181 may include more elements or fewer elements than those described above. Furthermore, the processor 830, transceiver 810, and memory 820 may be implemented in the form of a single chip. The network entities 103, 111, 121, 131, 151, 181 may include network functions (NFs) such as the access and mobility management function (AMF) 111, session management function (SMF) 121, policy and charging function (PCF) 161, network exposure function (NEF), unified data management (UDM) 151, and user plane function (UPF) described above. The network entity may also include a base station 131.

The transceiver 810, collectively referred to as including a receiver of the network entities 103, 111, 121, 131, 151, and 181 and a transmitter of the network entities 103, 111, 121, 131, 151, and 181, may transmit and receive signals to and from the UE 101 or other network entities. The signals transmitted and received may include control information and data. To this end, the transceiver 810 may include an RF transmitter configured to up-convert and amplify the frequency of the transmitted signal, and an RF receiver configured to low-noise amplify and down-convert the frequency of the received signal. However, this is only an embodiment of the transceiver 810, and the elements of the transceiver 810 are not limited to the RF transmitter and RF receiver. The transceiver 810 may include a wired or wireless transceiver, and may include various configurations for transmitting and receiving signals.

Further, the transceiver 810 may receive signals over a communication channel (e.g., a wireless channel) and output the signals to the processor 830, and transmit the signals output from the processor 830 through the communication channel.

In addition, the transceiver 810 may receive communication signals and output the communication signals to the processor, and transmit the signals output from the processor to the UE 101 or network entities 103, 111, 121, 131, 151, and 181 via a wired or wireless network.

The memory 820 may store programs and data required for operation of the network entities 103, 111, 121, 131, 151, and 181. Additionally, the memory 820 may store control information or data contained in signals obtained from the network entities 103, 111, 121, 131, 151, and 181. The memory 820 may include a storage medium, such as a ROM, RAM, hard disk, CD-ROM, and DVD, or a combination of storage media.

The processor 830 may control a series of processes to enable the network entities 103, 111, 121, 131, 151, and 181 to operate according to the embodiments of the disclosure described above. The processor 830 may include at least one processor. Methods according to the claims of this disclosure or embodiments described herein may be implemented in the form of hardware, software, or a combination of hardware and software.

It should be noted that the above-described structural diagram, an exemplary diagram of a method of transmitting a control/data signal, an exemplary diagram of an operation procedure, and structural diagrams are not intended to limit the scope of the disclosure. That is, all components, network entities, or steps of operation described in the embodiments of the disclosure should not be interpreted as being essential components for the implementation of the disclosure, and the disclosure may be implemented within the scope that does not impair the essence of the disclosure, by including only some components. Also, the respective embodiments of the disclosure may be combined with each other as required. For example, portions of the methods according to the disclosure may be combined with each other to enable a network entity and a terminal to operate.

In the above-described particular embodiments of the disclosure, components included in the disclosure are expressed in a singular or plural form according to the particular embodiments of the disclosure. However, the singular or plural form is appropriately selected for convenience of explanation and the disclosure is not limited thereto. As such, a component expressed in a plural form may also be constituted as a single component, and a component expressed in a singular form may also be configured as plural components.

Although specific embodiments have been described in the detailed description of the disclosure, various modifications are possible without departing from the scope of the disclosure. Therefore, the scope of the disclosure should not be limited to the described embodiments and should be determined by the claims described below as well as the claims and equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of operating a terminal in a wireless communication system, the method comprising:
transmitting a first registration request message to an access and mobility management function (AMF) through a base station;
receiving, as a response to the first registration request message, a registration rejection message from the AMF through the base station; and
transmitting, based on the registration rejection message, a second registration request message to the AMF through the base station.

2. The method of claim 1, wherein the first registration request message comprises:
a first indication requesting authentication of a network slice of the terminal in a unit of tracking area,
a second indication indicating that the terminal is capable of authenticating the network slice of the terminal in the unit of tracking area,
a third indication indicating that the terminal is capable of receiving and using authentication information of the network slice of the terminal, and
a fourth indication indicating that the terminal is capable of performing communication using the authentication information.

3. The method of claim 1, wherein the first registration request message comprises:
information about a tracking area associated with a network slice for which a service request is desired by the terminal, and
information about the network slice.

4. The method of claim 1, wherein the registration rejection message comprises:
at least one of a list of tracking areas determined based on the first registration request message,
information about a network slice available in a tracking area, and
authentication information for the network slice.

5. The method of claim 1, wherein the registration rejection message comprises:
a list of tracking areas determined based on the first registration request message, information about a network slice unavailable in a tracking area,
authentication information for the network slice, and
information about the network slice for which authentication failed in the tracking area.

6. The method of claim 1, wherein the registration rejection message comprises:
a list of tracking areas determined based on the first registration request message,
information about a network slice unavailable in a tracking area,
information about the network slice for which authentication has been attempted in the tracking area but has failed, and
authentication information for the network slice.

7. The method of claim 1, wherein the registration rejection message is generated based on a first authentication response message transmitted from a session management function (SMF) to an AMF, and
wherein the first authentication response message comprises a list of tracking areas determined based on the first registration request message, information about network slices available in tracking areas, and authentication information about the network slices.

8. The method of claim 7, wherein the first authentication response message is generated based on a second authentication response message transmitted from an authentication, authorization and accounting (AAA) to the SMF, and
wherein the second authentication response message comprises a first indication indicating that the wireless communication system has the capability of supporting and configuring the network slices in a unit of tracking area determined based on the first registration request message, and a second indication indicating that establishment, management, or authentication of the network slices in the unit of tracking area are permitted.

9. The method of claim 8, wherein the second authentication response message is generated based on an authentication request message transmitted from the SMF to the AAA, and
wherein the authentication request message comprises a tracking area code (TAC) and a granularity indication indicating that the terminal uses the network slices in the unit of tracking area determined based on the first registration request message.

10. The method of claim 9, wherein the authorization request message is generated based on network slice configuration information determined based on the first registration request message, and
wherein the network slice configuration information comprises at least one of an indication indicating that the granularity of mobility or authentication associated with the network slice for the terminal is configured in the unit of tracking area, and an indication indicating a mutual mapping relationship between information about the tracking area and authentication information about the tracking area.

11. A terminal in a wireless communication system, the terminal comprising:
a transceiver; and
a processor coupled to the transceiver, wherein the processor is configured to:
transmit a first registration request message to an access and mobility management function (AMF) through a base station;
receive, as a response to the first registration request message, a registration rejection message from the AMF through the base station; and
transmit, based on the registration rejection message, a second registration request message to the AMF through the base station.

12. The terminal of claim 11, wherein the first registration request message comprises:
a first indication requesting authentication of a network slice of the terminal in a unit of tracking area,
a second indication indicating that the terminal is capable of authenticating the network slice of the terminal in the unit of tracking area,
a third indication indicating that the terminal is capable of receiving and using authentication information of the network slice of the terminal, and
a fourth indication indicating that the terminal is capable of performing communication using the authentication information.

13. The terminal of claim 11, wherein the first registration request message comprises:
information about a tracking area associated with a network slice for which a service request is desired by the terminal, and
information about the network slice.

14. The terminal of claim 11, wherein the registration rejection message comprises:
at least one of a list of tracking areas determined based on the first registration message, information about a network slice available in a tracking area, and
authentication information for the network slice.

15. The terminal of claim 11, wherein the registration rejection message comprises:
a list of tracking areas determined based on the first registration message,
information about a network slice unavailable in a tracking area,
authentication information for the network slice, and
information about the network slice for which authentication failed in the tracking area.

16. The terminal of claim 11, wherein the registration rejection message comprises:
a list of tracking areas determined based on the first registration message,
information about a network slice unavailable in a tracking area,
information about the network slice for which authentication has been attempted in the tracking area but has failed, and
authentication information for the network slice.

17. The terminal of claim 11, wherein the registration rejection message is generated based on a first authentication response message transmitted from a session management function (SMF) to an AMF, and
wherein the first authentication response message comprises a list of tracking areas determined based on the first registration request message, information about network slices available in tracking areas, and authentication information about the network slices.

18. The terminal of claim 17, wherein the first authentication response message is generated based on a second authentication response message transmitted from an authentication, authorization and accounting (AAA) to the SMF, and
wherein the second authentication response message comprises a first indication indicating that the wireless communication system has the capability of supporting and configuring the network slices in a unit of tracking area determined based on the first registration request message, and a second indication indicating that establishment, management, or authentication of the network slices in the unit of tracking area are permitted.

19. The terminal of claim 18, wherein the second authentication response message is generated based on an authentication request message transmitted from the SMF to the AAA, and
Wherein the authentication request message comprises a tracking area code (TAC) and a granularity indication indicating that that the terminal uses the network slices in the unit of tracking area determined based on the first registration request message.

20. The terminal of claim 19, wherein the authorization request message is generated based on network slice configuration information determined based on the first registration request message, and
wherein the network slice configuration information comprises at least one of an indication indicating that the granularity of mobility or authentication associated with the network slice for the terminal is configured in the unit of tracking area, and an indication indicating a mutual mapping relationship between information about the tracking area and authentication information about the tracking area.
